(19) United States
(12) Patent Application Publication
(10) Pub. No.: US 2026/0074853 A1
(43) Pub. Date: Mar. 12, 2026

(54) RESPONSE MESSAGES IN ASYNCHRONOUS COMMUNICATIONS

(71) Applicant: Infineon Technologies AG, Neubiberg (DE)

(72) Inventor: Jens BARRENSCHEEN, München (DE)

(21) Appl. No.: 18/828,289

(22) Filed: Sep. 9, 2024

(51) Int. Cl. H04L 5/00; H04W 28/06

(52) U.S. Cl. CPC H04L 5/0048; H04L 5/0053; H04W 28/06

(57) ABSTRACT

An asynchronous communications system is described in which a responder node receives the frames of a message from a commander node and request frame in a predetermined position relative to the frames of the message. The responder node is configured to send a response in reply to the request frame. In some examples, the responder node sends the response frame while the responder node receives the request frame from the commander node.

### TECHNICAL FIELD OF THE INVENTION

This invention relates generally to communications systems, and more specifically to asynchronous data communications.

### BACKGROUND

In some applications, it may be beneficial to employ relatively low cost and/or low power communications systems. Some low cost/low power communications systems employ asynchronous communications techniques in which a central clock signal is not shared among nodes of the communications system. Instead, the nodes of the communication system are coupled via a common bus. The respective nodes of the communication system may be configurable as a commander node to send messages to other nodes as responder node(s).

In some applications of asynchronous communications, one or more responder node(s) may send a response message with an acknowledge in response to a message from a commander node. For example, such an acknowledgement may indicate to the commander node whether a sent message was received by the responder node(s). In other examples, a commander node may request send a request for data as part of a message to the responder node(s).

In traditional asynchronous communications systems, a responder node sends a response message based on timing of the responder node(s). For example, the responder node(s) may send a response message once the responder node(s) determines that the common bus is idle (no messages are being communicated), and/or after other messages have been communicated by the responder node(s).

In some examples of traditional asynchronous communications systems, a significant amount of computing power may be needed to the scheduling of execution tasks and communication by the respective nodes, which may increase the cost, complexity, and/or energy consumption of such systems.

### SUMMARY

This disclosure is directed to improvements in asynchronous data communications, specifically to enable responses to be communicated with reduced cost complexity and/or power consumption in comparison to traditional systems. For example, in some aspects, a method is described. The method includes receiving one or more data frames of a message, receiving a request frame in a defined position relative to the one or more data frames of the message, and sending, in response to the request frame, a response.

As another example, in some aspects, a communications node is described. The communications node is configured to: receive one or more data frames of a message, receive an request frame in a defined position relative to the one or more data frames of the message, and send, in response to the request frame, a response.

As another example, in some aspects, a system is described. The system includes a commander node and at least one responder node communicatively coupled to the commander node by a common bus. The responder node is configured to receive, from the commander node, one or more data frames of a message, receive, from the commander node, a request frame in a defined position relative to the one or more data frames of the message, and send, to the commander node in response to the request frame, a response.

### BRIEF DESCRIPTION OF THE DRAWINGS

FIG. 1 is a block diagram that depicts one example of an asynchronous communications system according to some embodiments.

FIG. 1B is a block diagram that depicts one example of an asynchronous communications system arranged to use full-duplex communications according to some embodiments.

FIG. 2 is a timing diagram that depicts one example of a UART message that may be transmitted from a UART transmitter to a UART receiver according to some embodiments.

FIG. 3 is a block diagram that depicts one example of a communications device according to some embodiments.

FIG. 4A is a timing diagram that depicts one example of communication between a commander node and one or more responder node(s) according to some embodiments.

FIG. 4B is a timing diagram that depicts one example of communication between a commander node and one or more responder node(s) according to some embodiments.

FIG. 5 is a timing diagram depicting a request frame sent from a commander node to a responder node, and a response frame generated by the responder node in response to the request frame according to some embodiments.

FIG. 6 is a flow diagram that depicts one example of a method of operating an asynchronous communications node according to some embodiments.

### DETAILED DESCRIPTION

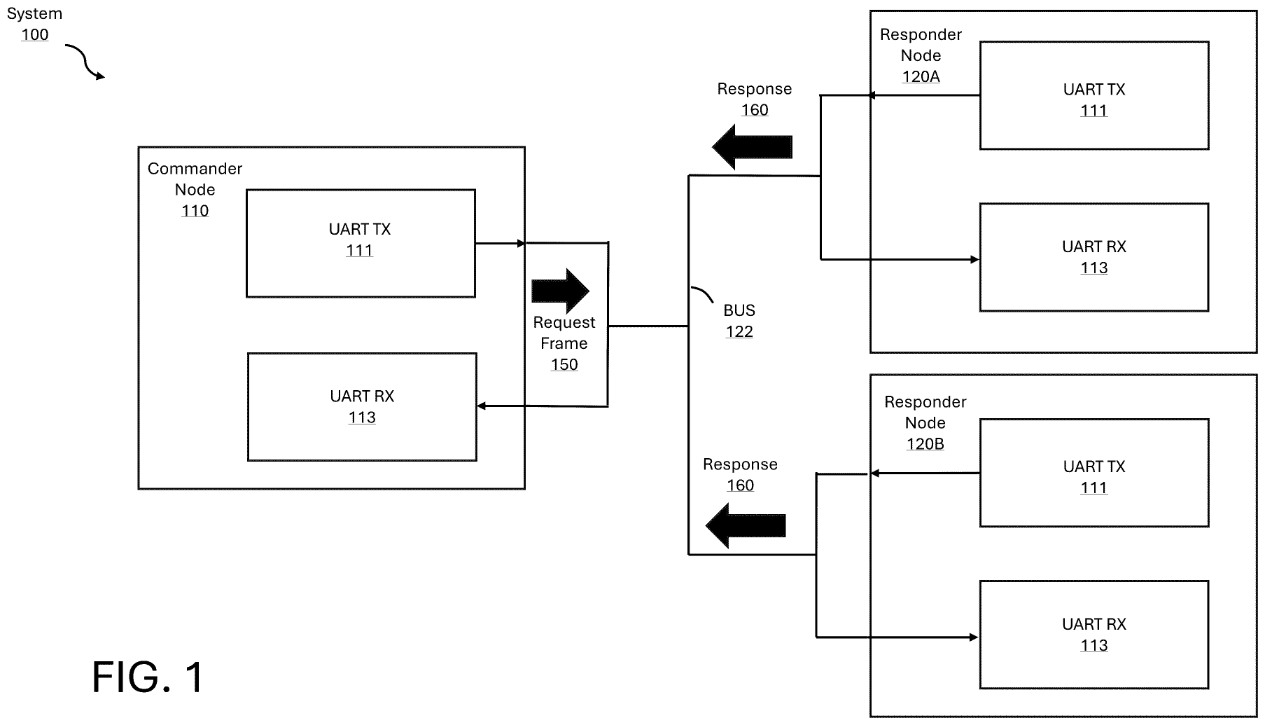

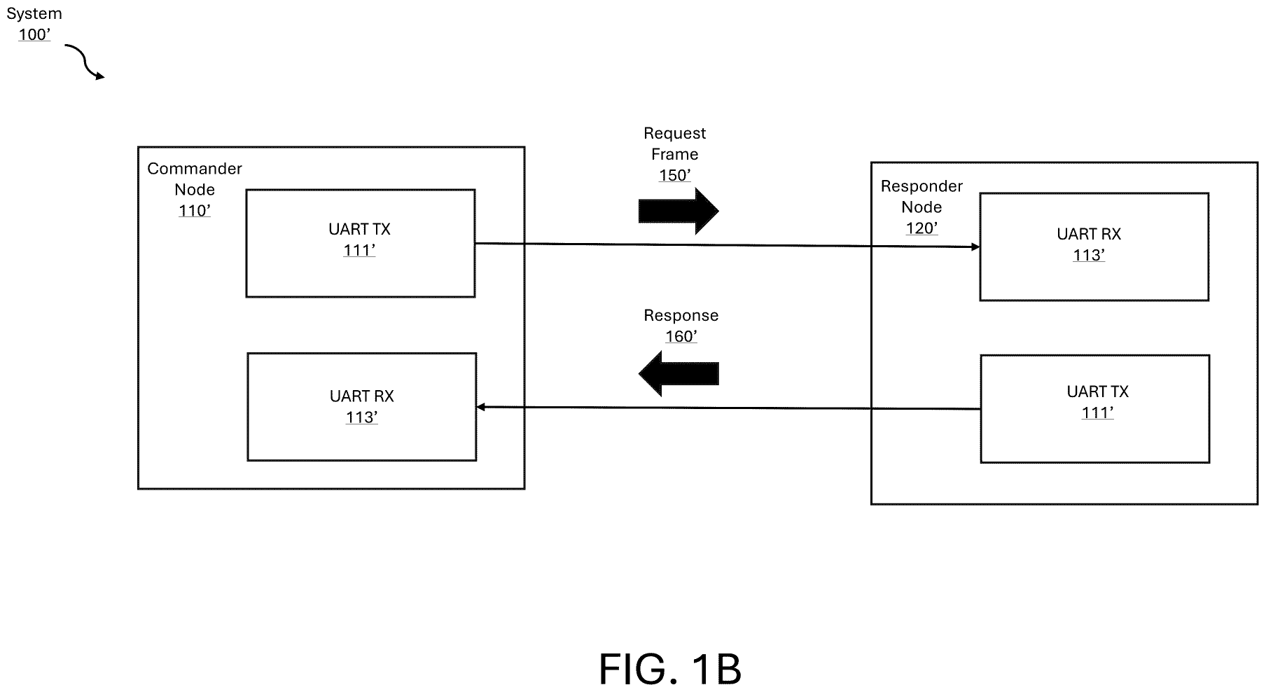

FIG. 1 is a block diagram that depicts one example of an asynchronous communications system 100 arranged to use half-duplex communications according to some embodiments. As shown in FIG. 1, system 100 includes a plurality of communications nodes 110, 120A, 120B communicatively coupled to a common bus 122. The plurality of communications nodes 110, 120A, 120B are configured to communicate asynchronously, i.e., based on a common bit rate without using a distributed clock signal.

In some examples, system 100 is configured to operate asynchronously, for example according to a Universal Asynchronous Receiver/Transmitter (UART) protocol. According to the UART protocol, nodes 110, 120A, 120B each include a UART transmitter 111 and a UART receiver 113 respectively configured to send and receive messages as data frames that with a predefined number of data bits. The connections between a UART transmitter and a UART receiver depicted in the figures show the flow of information from a transmitter to a receiver. The physical realization of these connections may comprise elements like wires, connectors, wire bonds, input stages, output stages, level shifters, logic gates, storage elements like flipflops or latches, isolating elements like inductive, capacitive or optical couplers, etc.

In the example of FIG. 1, system 100 is configured to operate using a “half-duplex” communications scheme in which respective nodes 110, 120A, 120B of the system 100 take turns communicating over a common bus 122. In a half-duplex communications scheme, only one node sends data to other nodes at a time, and data transmitted by one node is received by the other nodes.

In a half-duplex communication scheme, depending how system 100 is configured, a dominant bit may represent a high voltage level (logic 1) that overrides a recessive bit with a low voltage level (logic 0) on the common bus 122. In other examples, a dominant bit may represent a low voltage level (logic 0) that overrides a high voltage level (logic 1) on the common bus 122.

In the example of FIG. 1, a node 110 is configured as a commander node, and nodes 120A, 120B are configured as responder nodes. In some examples, a message 130 sent by the commander node 110 may include a request frame 150 that indicates a response 160 should be sent by at least one of the responder node(s) 120A, 120B that confirms whether the message 130 was received.

FIG. 1B is a block diagram that depicts one example of an asynchronous communications system 100 arranged to use full-duplex communications according to some embodiments. IN the example of FIG. 1B, a transmitter UART TX 111′ of a commander node 110′ is connected to a receiver UART RX 113′ of a responder node 120 via a first connection. UART transmitter 111′ of the responder node 120′ is connected to a UART receiver 113′ of the commander node 110 via a second connection. Using separate connections allows sending frames in parallel on both connections without the risk of data collision or data corruption.

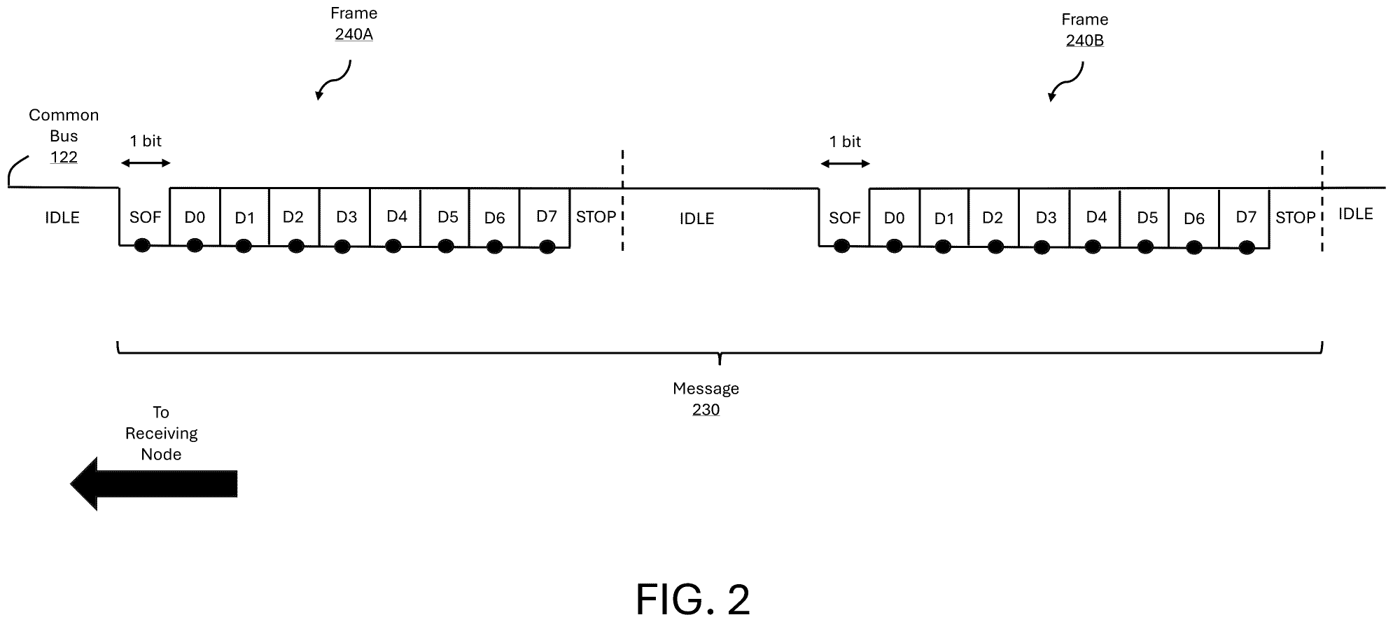

FIG. 2 is a timing diagram that depicts one example of a UART message 130 that may be transmitted from a UART transmitter 111 to a UART receiver 113 according to some embodiments. The message 230 may be sent, for example, by a UART transmitter 111 of a commander node 110 as shown in the example of FIG. 1 to send a message 230 to one or more responder nodes 120A, 120B. In other examples, the message 230 may be sent by a node configured as a responder node 120A, 120B to a commander node 110 and/or other responder nodes of system 100.

In the example of FIG. 2, the message 130 includes a plurality of UART frames 240A, 240B. According to the example of FIG. 2, system 100 is configured such that a dominant bit has low voltage level (logic 0), and a recessive bit has a high voltage level (logic 1). In other examples not depicted, a dominant bit may have a high voltage level (logic 1), and a recessive bit a low voltage level (logic 0). According to the example of FIG. 2, the message 230 includes two frames 240A, 240B each with a predetermined number of bits, eight in the FIG. 2 example. In other examples, a message may include a larger predetermined number of N frames. As one non-limiting example, if implemented according to a Local Interconnect Network (LIN) protocol, message 130 may include eight frames that each include eight bits (a byte) of data.

As shown in FIG. 2, the respective bits of the frames 240A and 240B are separated by a bit length of 1 bit. The black dots in FIG. 2 represent times at which each bit of the frames 240A and 240B are sampled by one or more UART receiver(s) 113 that receive the message 230 based on the bit length.

As shown in FIG. 2, to communicate the message, when common bus 122 is in an IDLE state (recessive representing a logic high (1)), the UART transmitter 111 begins outputting a first frame 240A of the message 230 by outputting a Start of Frame (SOF) bit on the common bus 122. The SOF bit may have a dominant voltage level (i.e., logic low (0) in the FIG. 2 example), and signal to UART receiver(s) 113 that frame 240A is to be communicated. After the SOF bit, the UART transmitter 111 sequentially outputs eight bits of data D0-D7, which each represent a bit of the message 230 being communicated are dominant (logic high (1)) or recessive (logic low (0)).

After outputting the data bits D0-D7, the UART transmitter 111 outputs at least one STOP bit (in examples not depicted, message 130 may include one or more further STOP bits), which may have a recessive voltage level (logic high (1) in the FIG. 2 example) to signal that communication of the frame 240A has ended. After the STOP bit(s) are communicated, the common bus 122 returns to an IDLE state (i.e., with a recessive voltage level).

At some time after outputting the at least one STOP bit, the UART transmitter 111 similarly outputs frames of the message 230 such as frame 240B depicted in FIG. 2, outputting a dominant SOF bit, followed by a plurality of data bits D0-D7, followed by at least one stop bit that indicates transmission of the frame 240B has ended. The UART transmitter 111 continues likewise to output further frames of the message 130 not depicted in FIG. 2, until a last frame of the message has been transmitted. According to the non-limiting example of a LIN protocol referenced above, a UART transmitter may send messages that each include eight frames of data.

According to traditional asynchronous protocols, a commander node may request a response by including a signal, i.e., one or more bits of a message that indicate that a confirmation of receipt, or data, should be sent in reply by the responder node(s). According to a traditional asynchronous protocol, in response to such a signal, a responder node sends a response via a traditional UART message as shown in FIG. 2 at a time defined by the responder node, e.g. after the commander node has finished transmitting. According to a traditional asynchronous communication system, a responder node sends a response after the commander node has finished transmission of a message. In this case, the traditional responder node replies by sending at least one frame to finish the message. To avoid collision of transmitting nodes in a traditional asynchronous communication system, the commander node and the responder node(s) check if the bus is idle before starting transmission of frames. As soon as the start of a frame is detected on the bus by a traditional communication node, it may not start frame transmission and wait until the bus is idle again.

As one example of such a response, a traditional responder node may send a response when the responder node determines that the common bus is IDLE and therefore available for data to be sent, and/or when the traditional responder node schedules the response, which may be at a time unknown to a traditional commander node. In some examples, a traditional commander node may be forced to wait until confirmation that a message has been received from a responder node before performing other tasks, such as transmitting further messages. In some examples, a commander node of a traditional synchronous protocol may use a timeout mechanism to stop waiting for a response from a responder node, e.g. to avoid waiting too long for the responder node to send a response. Changing the operation of a commander node between transmitting, waiting for a response, checking for a timeout and then starting to transmit a next message may lead to an increased need for computing power. Changing the operation of a responder node between receiving a message, waiting for the bus to become idle, sending requested data and/or confirmation of receipt and then preparing to receive another message may lead to an increased complexity of the circuit. In one particular example, the transmission of a sequence of messages by the traditional commander node may increase the need for computing power if a response from a responder node is expected between two or more messages sent by the commander node.

In some examples, asynchronous communications may be implemented with many nodes, for example ten, twenty, or even more nodes. In some examples of traditional asynchronous systems, coordinating the changes between transmission and reception of messages may require a significant amount of computing power to effectively manage data transfers between locations in data memory and the UART transmitter and the UART receiver, especially at fast speeds. In some examples, the required computing power may increase the cost, power usage, and/or complexity to implement asynchronous communications.

System 100 depicted in FIG. 1 is configured to handle confirmations of message receipt and/or requests for data in a unique manner, to enable asynchronous communications with reduced complexity, cost and/or power consumption in comparison to traditional systems. As shown in FIG. 1, a commander node 110 is configured to send messages 130 to the responder node(s) 120A, 120B with an associated request frame 150 that signals to the responder node(s) 120A, 120B that a response 160 should be sent by the responder node(s) 120A, 120B. The response 160 may indicate whether the message 130 was received by the responder node(s) 120A, 120B. In some examples, the request frame 150 also or instead requests data in response to the request frame 150, the receipt of which may also confirms the message 130 was received by the responder node(s) 120A, 120B.

In some examples, the request frame 150 may signal to the responder node(s) 120A, 120B that confirmation of message receipt and/or data has been requested if the request is received by the responder node(s) 120A, 120B in a predetermined position relative to the position of the frames in a message 130.

For example, the request frame 150 may be a frame of a message, and the position of the frame relative to other frames of the message identifies the frame as a request frame 150. For example, the request frame 150 may be identified as a request frame as opposed to a data frame by the responder node 120A, 120B based on an order in which the request frame is received by the responder node 120A, 120B. As a non-limiting examples, both the commander node and the responder node may be programmed to identify a fourth frame of each message, a second frame of each message, a first frame, and/or a last frame of each message as a request frame in each message 130.

As another example, that confirmation of message receipt and/or data has been requested in an additional frame of data within a predetermined time after the responder node 120A, 120B receives a last data frame of a message, i.e., at a time before the host node 110 would typically start sending a further message (e.g., further data frames of a further message after completing transmission of a message).

In some examples, a commander node 110 may introduce a request frame 150 at a defined position in or after the message 130 that indicates when the requested responder node(s) 120A, 120B are to send a response 160. For example, the responder node(s) 120A, 120B may send the response 160 during a time period defined by the request frame 150. In contrast with a traditional responder node, the responder node(s) 120A, 120B may use the received start of frame (SOF) bit of the request frame 150 to start the transmission of a response 160, instead of waiting for the bus to be idle. In one embodiment, the commander node 110 sends a request frame 150 with recessive data bits that follow a dominant SOF bit. For example, if the responder node(s) 120A, 120B detect the beginning of a frame (e.g., a start of frame “SOF” bit), and send the response 160 while the host node 110 is sending the request frame 150. In some examples, the position of a request frame 150 in a message 130 is known by the relevant communication nodes, the responder node(s) 120A, 120B send the response 160 responsive to a Start of Frame (SOF) bit of the request frame 150, and send the response 160 while bits (i.e., (recessive bits)) of the request frame 150 are being output by the host node 110.

Although not depicted in FIG. 1, in some examples, the response 160 sent by the responder node(s) 120 may be a response frame analogous to the UART data frames depicted in FIG. 2 and including an SOF bit followed by a plurality of data bits. In some such examples, the response frame includes a plurality of acknowledgement bits following the SOF bit that confirm whether or not a message was successfully received by the responder nodes 120A, 120B. In other examples, such a response includes bits of data, for example communicating information such as sensor data or other information requested by the commander node 110.

System 100 depicted in FIG. 1 may offer significant advantages in comparison to traditional asynchronous communications systems. For example, system 100 may enable responses from a responder node 120A, 120B to be sent at a time defined by a commander node 110 that sent a message 130, which may enable system 100 to be implemented with reduced cost and/or complexity, and/or with reduced energy consumption in comparison with traditional asynchronous communications systems. For example, system 100 may be implemented with less computing power dedicated to the scheduling of messaging than traditional systems in some applications, because the transmitter of the commander node may remain in transmission mode and may not need to be switched off and/or rendered idle while receiving data from a responder node. In half-duplex mode as well as in full-duplex mode, the commander node may be built in a more efficient way if it controls the transmission of response frames by a responder node, because the overall timing and the amount of frames transferred are always controlled by the commander node.

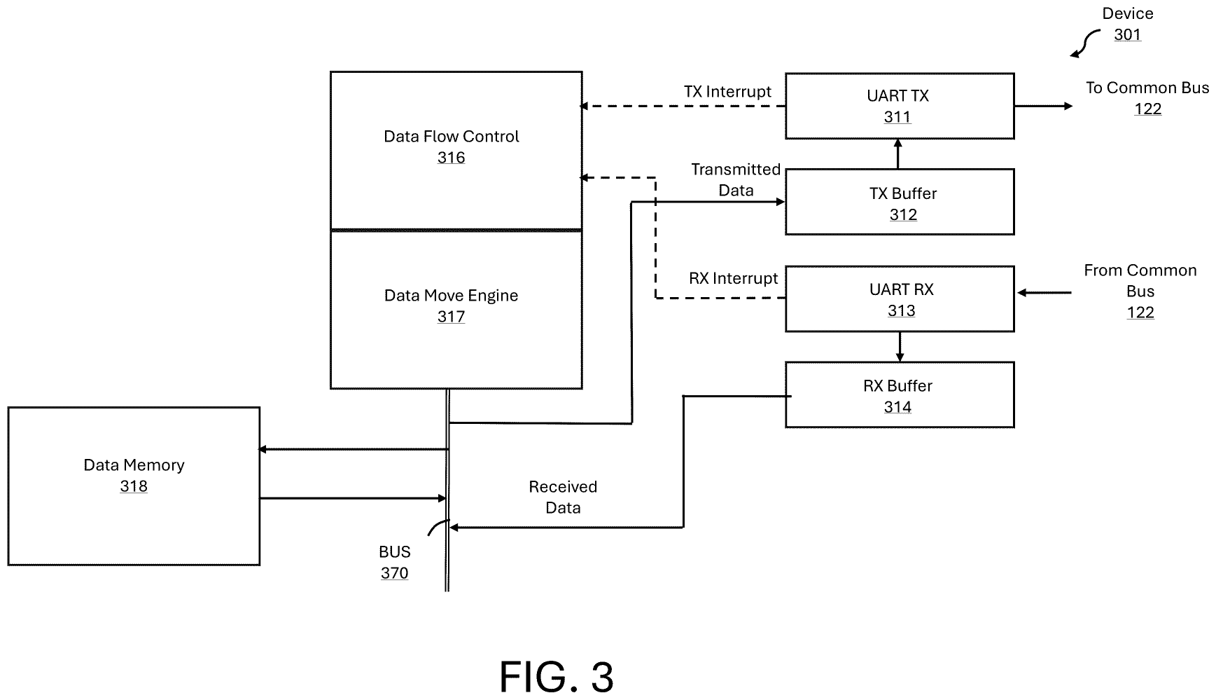

FIG. 3 is a block diagram that depicts one example of a communications device 301 that may be used as a commander node 110 in an asynchronous communication system 100 as depicted FIG. 1 according to some embodiments. In some examples, device 301 may be configurable to send messages to responder nodes via a common bus 122.

As shown in FIG. 3, device 301 includes a UART transmitter 311, a UART receiver 313, and a data flow control module 316 and a data move engine 317. As shown in FIG. 3, the data move engine 317 is coupled via a data bus 370 to a data memory 318, which may store one or more messages to be communicated that are arranged into frames of data like frames 240A, 240B depicted in FIG. 2. The data move engine 317 may include a Direct Memory Access (DMA) controller or other device configured to copy data from one memory to another. The data flow control module 316 may include any combination of hardware circuitry and/or executable software instructions configured to control the flow of data and/or messaging associated with device 301.

The UART transmitter 311 is coupled to a transmit buffer 312 to store bits of data as shown in the example of FIG. 2. The data memory 318 may have significantly more storage capacity than the transmit buffer 312, which may store bits of one or multiple UART frames of one or more messages for transmission. To communicate a message, the data move engine 317 transfers data bits into the transmit buffer 312, and the UART transmitter 311 sends the data bits in frames, by first outputting an SOF bit followed by the data bits, followed by at least one STOP bit that indicates the frame has been transferred. When there is space in the transmit buffer 312, the UART transmitter 311 sends a transmit interrupt signal to the data flow control module 316. Based on the transmit interrupt signal, the data flow control module 316 may cause the data move engine 317 to transfer further bits from the data memory 318 to the transmit buffer 312, to be output via the via the common bus 122.

The UART receiver 313 stores data bits received via the common bus 122 in a receive buffer 314. The data move engine 317 transfers data bits from the receive buffer 314 to the data memory 318. Once the UART receiver 313 has stored a predetermined number of data bits (i.e., a predetermined number of frames) in the receive buffer 314, the UART receiver 313 generates a receive interrupt to indicate that the stored data bits can be transferred to data memory 318. As a non-limiting example, the UART receiver 313 may send the receive interrupt signal when four UART frames, including 32 data bits, are stored in the receive buffer 314.

In some examples of traditional UART devices, a significant amount of computing power may be needed to interact regularly with the data flow control module 316 (i.e., via the respective transmit and receive interrupts) to in order to schedule messaging between the commander node 110 and responder nodes 120A, 120B. In some examples, device 301 is uniquely configured to signal to the responder node(s) a request frame 150 that causes the responder node(s) 120A, 120B to send a response 160 without requiring significant CPU resources.

In an example of a traditional asynchronous communications protocol, a commander (?) node (e.g., a UART host node), a traditional data flow control module of a commander node transfers a defined number of transmit data words to a Tx buffer, leading to a defined number of UART frames to be sent out, e.g. representing a host node part of a message. Before moving the next transmit data words to the Tx buffer, the traditional data flow control module may be forced to wait for the reception of a defined number of received UART frames by a UART receiver, e.g. indicated by Rx interrupts. Received data may represent a response to a message previously sent by the commander node. The data of the received frames is moved from the Rx buffer to data memory by a data move engine. How many transmit data words are to be moved to the Tx buffer and how many UART frames are to be received from a responder node to complete communicating a message may be available in the data flow control unit. This may lead to increased area or effort, especially if a sequence of messages of different sizes (e.g., different numbers of frames) of the commander node message and responder node messages have to be transferred.

Referring back to FIG. 1, the effort to handle the sequences of messages from the master node 110 and/or responder node(s) 120A, 120B to the responder node 120, or from the master node 110 to the responder node(s) 120A, 120B can be significantly reduced. According to the FIG. 1 example, the commander node 110 may send request frames 150 that trigger to an immediate response 160 transmitted by a responder node(s) 120A, 120B. In some examples, the number of request frames 150 to be sent out additionally by the commander node 110 may be equal to the amount of expected responder node 120A, 120B frames for that message. In some examples, the commander node 110 sends out as many frames per message as it receives. According to system 100 depicted in FIG. 1, the commander node 110 may not need to wait for the reception of a defined number of responder node frames (e.g., as a response) before being able to start sending a new message. In some examples, a duration of a message is not increased by the additional request frames 150. In some examples, a number of additional request frames 150 are equal to an expected number of responses 160 to finish that message. In some examples, a new message may be started immediately after the last frame of a previous message from the commander node 110 has been sent out.

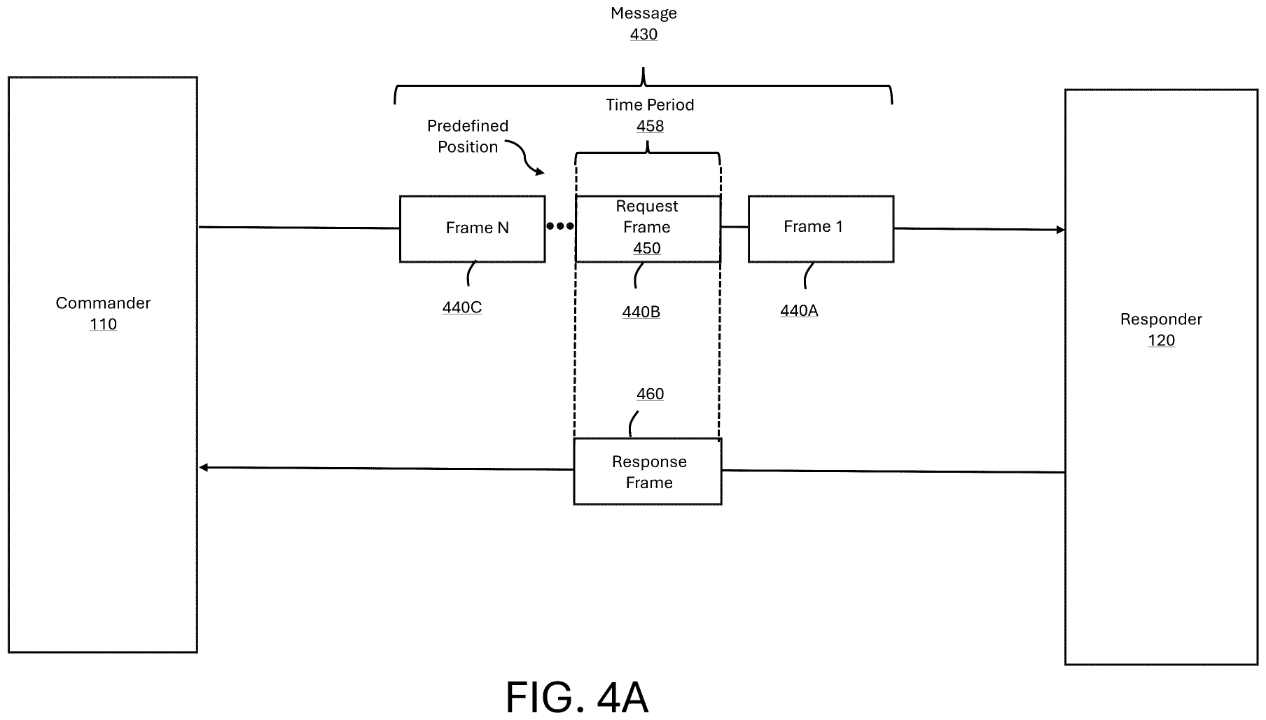

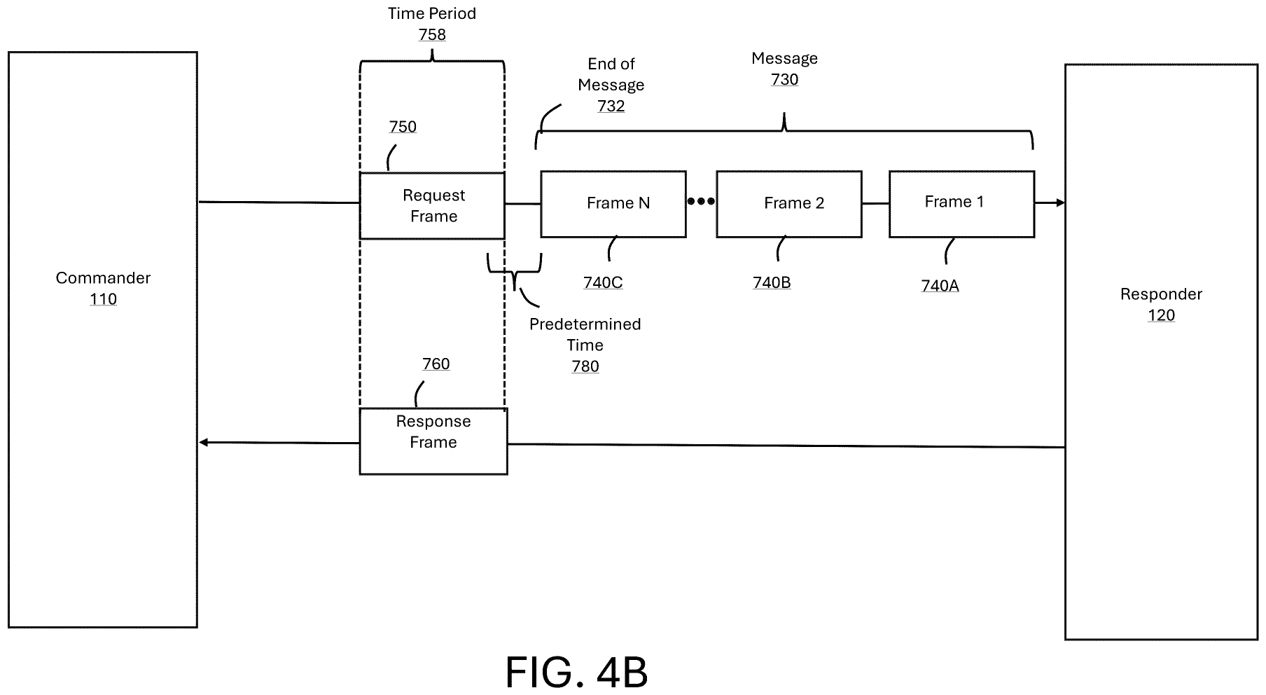

FIG. 4A is a timing diagram that depicts one example of communications between a commander node 110 and one or more responder node(s) 120 according to some embodiments. In the example of FIG. 4A, the commander node 110 is operable to send a message 430 to the responder node(s) 120, and request a response from the responder node 120 that confirms that the message 430 was received and/or that the includes data requested by the commander node 110.

According to the example of FIG. 4A, the message 430 includes a plurality of N frames 740A-740C that each include a plurality of data bits as described above with respect to FIG. 2. In some examples, the message 430 includes more than one frame. For example, the message 430 may include 2, 4, 6, 8, 10, 12, or even more frames. Each of the frames 440A-440C may include the same number of data bits. As a non-limiting example, each of the N frames may include 8 data bits, i.e., a byte of data. In other examples the N frames may include more or fewer data bits. For example, the N frames may include 9 bits. The N frames 440A-440C may be communicated as UART frames 240A, 240B as depicted in FIG. 2.

To transmit the message 430 to the responder node 120, the commander node 110 sends each frame of data: first a frame 1 440A, then a frame 2 440B, then further frames not depicted in FIG. 4A, and so on until a last (Nth) frame 440C is sent, completing transmission of the message 730.

According to the example of FIG. 4A, the commander node 110 is configured to request a confirmation from the responder node 120 that indicates whether the message 430 or frames of the message 430, including one or more of the plurality of N frames collectively or singularly, was received by the responder node 120 by sending a frame of 440B of the message 430 as a request frame 450.

In the example of FIG. 4A, the commander node 110 sends the request frame 450 in a defined position relative to the other depicted frames 440A and 440C of the message 430, for example in a second frame position in the message 430. Although FIG. 4A shows the request frame in a middle, or second, position in the message 430, other frames of the message 430 may be used as a request frame 450 instead, including a first frame 440A of the message 430, a last frame 440C of the message 430, or any of the frames in between the first frame 440A and the last frame 440C if the message 430 includes more frames than depicted in the FIG. 4B example.

According to the example of FIG. 4A, the responder node 120 is configured to identify whether the commander node 110 requested confirmation of the message 430 based on whether a request frame 450 is received as a frame of the message 430 at a defined position relative to other of the N frames of the message 430. For example, the responder node 120 may identify whether the request frame 450 (e.g., an SOF bit of the request frame 450) is received in a defined position relative to other frames (e.g., in a second frame position in a message that includes 6 frames). In some examples, the responder node(s) are programmed to identify a request frame 450 in the same position relative to other frames for each message received by the commander node 110.

In some examples, the commander node 110 is configured to send multiple frames 440A-440C of a message 430 as request frames 450, each configured to request confirmation that one or more preceding frames of the message were received and/or to request data from the responder node(s) 120. For example, the commander node 110 may be configured to send a request frame 450 each M frames of a message. As one non-limiting example, for a message with 15 frames, the commander node 110 may send a request frame 450 every fifth frame of the message.

The commander node 110 may send a sequence of request frames 450 to control the start of each responder node frame by an individual request frame. The responder node(s) 120 may start transmission of a response 460 related to a defined position within the message 230, e.g. a first request frame of the message 230 may trigger the transmission of a response frame of a first responder node 120A and a second request frame of the message 230 may trigger the transmission of a response 460 of a second responder node 120B. In another example, a first request frame 450 of a message 230 may trigger the transmission of a first response of a responder node 120A, and a second request frame of the message 230 may trigger the transmission of a second response of the responder node 120B. In another example, a request frame 450 may trigger transmission of responses 460 of several responder nodes. In this case, a dominant data level of one responder node may overrule a recessive data level of another responder node in the response 460 received by the commander node 110.

In some examples, the responder node 120 is configured to send a response 160 as a response frame 460 as shown in FIG. 4A. According to this example, the response frame 460 includes a frame of data, like the UART frames 240A, 240B depicted in the example of FIG. 2. In some examples, the responder node 120 sends the response frame 460 during a time period 458 defined by the request frame 450. For example, as shown in FIG. 4A, the responder node 120 may send the response frame 460 while the commander node 110 is sending the request frame 450, which is while the commander node 110 is sending the message 430.

FIG. 4B is a timing diagram that depicts one example of communications between a commander node 110 to one or more responder node(s) 120 according to some embodiments. In the example of FIG. 4B, the commander node 110 is operable to send a message 730 to the responder node 120, and request a response from the responder node 120 that confirms that the message 730 was received and/or that includes data requested by the commander node 110.

According to the example of FIG. 4B, the message 430 includes a plurality of N frames 740A-440C that each include a plurality of data bits as described above with respect to FIG. 2. In some examples, the message 730 includes more than one frame. For example, the message may include 2, 4, 6, 8, 10, 12, or even more frames. Each of the frames 740A-740C may include the same number of data bits. As a non-limiting example, each of the N frames may include 8 data bits, i.e., a byte of data. In other examples the N frames may include more or fewer data bits. For example, the N frames may include 9 bits. The N frames 740A-740C may be communicated as UART frames 240A, 240B as depicted in FIG. 2.

To transmit the message 730 to the responder node 120, the commander node 110 sends each frame of data: first a frame 1 740A, then a frame 2 740B, then further frames not depicted in FIG. 4B, and so on until a last (Nth) frame 740C is sent, completing transmission of the message 430.

According to the example of FIG. 4B, the commander node 110 is configured to request a confirmation from the responder node 120 that indicates whether the message 430, including the plurality of N frames, was received by the responder node 120 and/or requested data by sending a frame of data, like the frames 240A, 240B, of message 730 depicted in FIG. 2, as a request frame 450.

In the example of FIG. 4B, the commander node 110 sends the request frame 750 in a defined position relative to the N frames 740A-740C of the message 730, for example after frame N of the message 730 (e.g., after a STOP bit (not shown in FIG. 4B) of a last (Nth) frame 440C of the message 730). For example, as shown in FIG. 4B, the commander node 110 may send the request frame 750 (e.g., send an SOF bit of a UART frame 240A, 240B as shown in FIG. 2) within a predetermined time 780 after an end 732 of the commander part of message 730. In some examples, the predetermined time 780 is less than the commander node 110 typically pauses between messages (between sending a last frame of a message, and a first frame of a next message).

According to the example of FIG. 4B, the responder node 120 is configured to identify whether the commander node 110 requested confirmation of the message 730 based on whether a request frame 750 is received at a defined position relative to receiving the N frames of the message 730. For example, the responder node 120 may identify whether the request frame 750 (e.g., an SOF bit of the request frame 750) is received within the predetermined time 780 after the end 732 of the message 730. In some examples, if no further frame (e.g., no SOF bit) is received within the predetermined time 780, the responder node 120 does not identify a request for confirmation that the message 730 was received and does not send any response.

In some examples, when the responder node 120 identifies a request frame 750 as described above, the responder node 120 sends a response as a response frame 760 as shown in FIG. 4B. According to this example, the response frame 760 includes a frame of data, like the UART frames 240A, 240B depicted in the example of FIG. 2. In some examples, the responder node 120 sends the response frame 760 during a time period 758 defined by the request frame 750. For example, as shown in FIG. 4B, the responder node 120 may send the response frame 760 while the commander node 110 is sending the request frame 750.

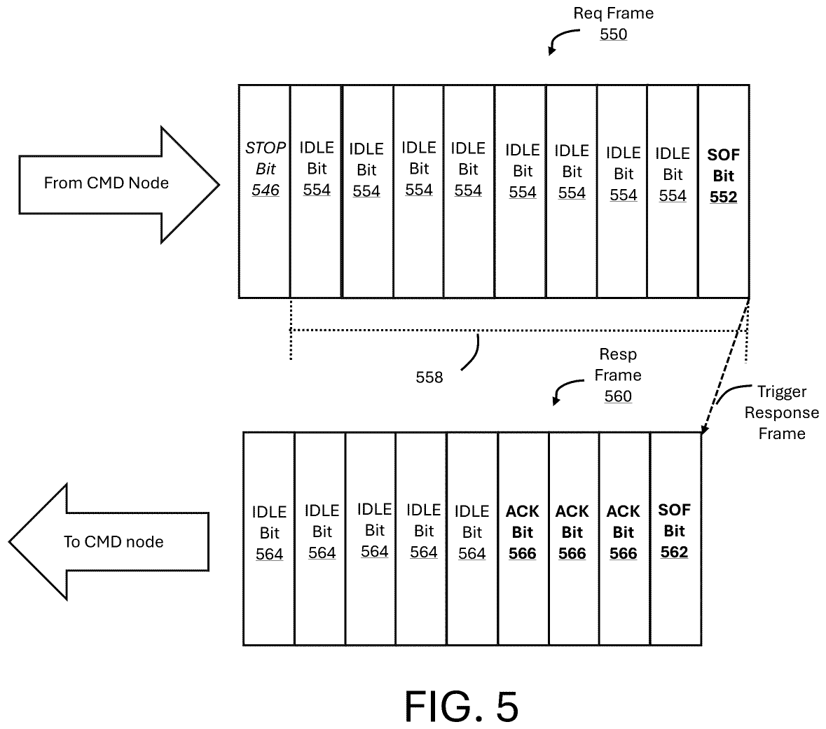

FIG. 5 is a timing diagram depicting an example of a request frame 550 sent from a commander node 110 to a responder node 120, and a response frame 560 generated by the responder node 120 in response to the request frame 550 according to some embodiments. In some examples, the request frame 560 is sent as a frame of a message 730 as shown in the FIG. 4A example. In other examples, the request frame 560 is sent after the frames 4400A-440C of a message 430 as shown in the FIG. 4B example.

According to the example of FIG. 5, to request response from the responder node 120, the commander node 110 sends a request frame 550 at a predefined position. In some examples, a request frame contains data bits that are not intended to be interpreted by a responder node. These bits are transferred by the commander node to avoid stopping transmission and to stay within its timing sequence for the frame transfers. One solution for such bits is to transmit bits at recessive (IDLE) level, because they are overruled by any dominant level sent out by a responder node. In these examples, the dominant SOF bit sent by the commander node is the only bit of a request frame considered by a responder node. Like the frame(s) 240A, 240B of message 230 depicted in FIG. 2, the request frame 550 includes an SOF bit 552 with a dominant level followed by the predetermined number of data bits (8 bits in the FIG. 5 example). In the example of FIG. 5, the predetermined number of data bits 554 are IDLE (recessive) data bits. In other examples, not all of the data bits are IDLE (recessive bits). For example, at least some of the predetermined number of bits 554 are dominant bits.

As also shown in FIG. 5, the responder node(s) 120 may send a response at a time defined by the request frame 550. As depicted in FIG. 5, the response frame 560 includes a dominant SOF bit 562 followed by a plurality of acknowledgement bits 566 configured to confirm, to the commander node 110, whether the message or frame was received by the responder node 120 to the commander node 110. According to the example of FIG. 5, the acknowledgement bits 566 include three out of the eight data bits of the acknowledgement response frame 560. In other examples, the response frame 560 includes more or fewer acknowledgement bits 566 arranged at the same or different position in the response frame 550. As shown in FIG. 5, the response frame 560 may include IDLE (recessive) bits 564 that follow the acknowledgment bits 566. In some examples, a first responder node may be configured to send dominant level at a first bit position after receiving the SOF of a request frame, whereas a second responder node is configured to send dominant level at a second bit position of the same request frame.

In other examples, a response frame 560 may not include acknowledgement bits 566 as shown in FIG. 5. For example, a commander node 110 may send a request frame 550 that indicates that data should be send in response to a previous request for data, for example sent in a previous message or frame. According to such examples, one or more bits of the response frame 560 may include data bits with a dominant or recessive value to represent data requested by the commander node 110.

In the example of FIG. 5, the responder node(s) 120 send the response frame 560 during a time period 558 defined by the request frame 550. For example, as shown in FIG. 5, the responder node(s) 120 sends the acknowledgement bits 566 of the response frame 560 while at least some of the IDLE bits 554 of the request frame 550 are being sent by the commander node 110 to the responder node 120. In some examples, the acknowledgement bits 566 are dominant data bits that override the IDLE bits of the request frame 550. In other examples, the acknowledgement bits 566 are recessive bits, maintaining a recessive level on the common bus 122. In still other examples, the response frame 560 does not include acknowledgment bits, and instead includes dominant and/or recessive data bits that represent data requested by the commander node 110.

In some examples, system 100 may be configured to send response frames 560 in different ways. For example, system 100 may be configured such that the responder node(s) 120 actively signal a positive confirmation each time a message 530 is successfully received by the responder node(s) 120. According to these examples, the commander node 110 is configured to identify a successful transmission of message 530 if a response frame 560 is received that includes dominant acknowledgement bits 566 (or data bits) that override the IDLE bits 554 of the request frame 550 on the common bus 122 during the time period 558. According to these examples, the commander node 110 is configured to identify a message transmission failure and resend the message 530 if a response frame 560 is not received during the time period 558, or if an response frame 560 includes recessive acknowledgement bits 566 that do not overring the IDLE bits of the acknowledgment request frame 550 during the time period 558.

In other examples, system 100 is configured such that the responder node(s) 120 actively signal a negative confirmation each time a message 530 is not correctly received by the responder node(s) 120, i.e., when transmission of the message 530 failed or data corruption has been detected. According to these examples, the commander node 110 identifies a transmission failure if a response frame 560 is received that includes dominant acknowledgement bits 566 (or data bits) that override the IDLE bits of the request frame 550 during the time period 558. According to these examples, the commander node 110 is configured to identify a successful message transmission if a response frame 560 includes recessive acknowledgement bits 566 that do not override the IDLE bits of the request frame 550 is received during the time period 558, or if a response frame 560 is not received during the time period 558.

Regardless of how system 100 is configured, the commander node 110 may take actions to mitigate an identified transmission failure. For example, the commander node 110 may resend a message 530 to the responder node(s) 120 if a transmission failure is identified.

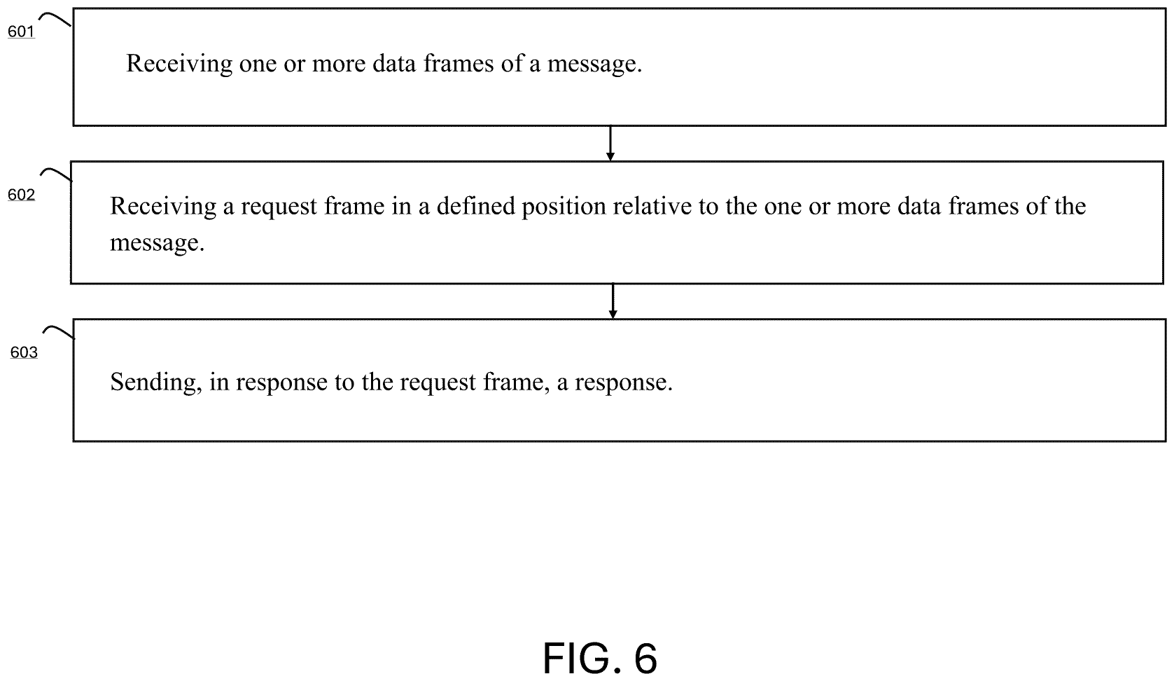

FIG. 6 is a flow diagram that depicts one example of a method of operating an asynchronous communications node according to some embodiments. As shown in FIG. 6, at step 601, the method includes receiving one or more data frames 440A-440C of a message 230. The data frames 440A-440C may include a start of frame (SOF) bit 542 followed by a predefined number of data bits 544 that are dominant or recessive bits.

As shown in FIG. 6, at step 602, the method further includes receiving a request frame 450 in a defined position relative to the data frames 440A-440C of the message 430. In some examples, the method further includes receiving the request frame 450 within a predetermined time 480 after receiving a last data frame of the message 430. In other examples, the method further includes receiving the request frame 450 within a predetermined time 480 after receiving a last data frame of the message 430.

As shown in FIG. 6, at step 603, the method further includes sending, in response to the request frame 150, a response 160. The response 160 may confirm whether or not a message or frame was received, and/or may include data. In some examples, the method further includes sending the response 160 during a time period defined by the request frame 150. In some examples, the method further includes sending the response 160 while receiving the request frame 150 (i.e., while the host node 110 is sending the request frame 150). In some examples, the method further includes sending the response responsive to detecting an SOF bit 552 of the request frame 150. In some examples, the response is a response frame 460 that includes acknowledgement bits 566 followed by a plurality of IDLE bits 564. In some examples, the plurality of acknowledgement bits 566 are dominant bits that override IDLE (recessive) bits 554 of the request frame 450. In other examples, the plurality of acknowledgement bits 566 are recessive bits that do not override the IDLE bits 554 of the request frame 550. In some other examples, the response frame 460 does not include acknowledgement bits 566, and instead includes dominant and recessive data bits that represent data requested by a commander node 110. In some examples, the response indicates whether the message or the frame of the message was received. In some examples, the response includes requested data.

In some examples, the data frames 440A-440C of the message 430, the request frame 450, and the response frame 460 are Universal Asynchronous Receiver/Transmitter (UART) frames that, for example, include a start of frame (SOF) bit followed by a predetermined number of data bits.

### Clauses

Clause 1. A method, comprising: receiving one or more data frames of a message; receiving a request frame in a defined position relative to the one or more data frames of the message; and sending, in response to the request frame, a response.
Clause 2. The method of clause 1, further comprising: receiving the request frame as a frame of the message in a predetermined order within the message.
Clause 3. The method of any of clauses 1 and 2, further comprising: receiving the request frame within a predetermined time after receiving a last data frame of the message.
Clause 4. The method of any of clauses 1-3, further comprising: sending the response while receiving the request frame.
Clause 5. The method of any of clauses 1-4, further comprising: sending the response during a time period defined by the request frame.
Clause 6. The method of any of clauses 1-5, further comprising: sending the response responsive to an SOF bit of the request frame.
Clause 7. The method of any of clauses 1-6, wherein sending the response comprises sending a response frame.
Clause 8. The method of clause 7, wherein the response frame includes a start of frame bit followed by a plurality of acknowledgment bits.
Clause 9. The method of clause 8, wherein the plurality of acknowledgement bits are dominant bits.
Clause 10. The method of clause 8, wherein the plurality of acknowledgement bits are recessive bits.
Clause 11. The method of any of clauses 1-10, wherein the response indicates whether the message or the frame of the message was received.
Clause 12. The method of any of clauses 1-11, wherein the response includes requested data.
Clause 13. A communications node configured to: receive one or more frames of a message; receive a request frame in a defined position relative to the one or more frames of the message; and send, in response to the request frame, a response.
Clause 14. The communications node of clause 13, wherein the communications node is further configured to: receive the request frame as a frame of the message in a predetermined order within the message.
Clause 15. The communications node of any of clauses 13 and 14, wherein the communications node is further configured to: receive the request frame within a predetermined time after receiving a last data frame of the message.
Clause 16. The communications node of any of clauses 13-15, wherein the communications node is further configured to: send the response while receiving the request frame.
Clause 17. The communications node of any of clauses 13-16, wherein the communications node is further configured to: send the response during a time period defined by the request frame.
Clause 18. The communications node of any of clauses 13-17, wherein the communications node is further configured to: send the response responsive to an SOF bit of the request frame.
Clause 19. The communications node of any of clauses 13-18, wherein the communications node is further configured to: send the response as a response frame.
Clause 20. The communications node of clause 19, wherein the response frame includes a start of frame bit followed by a plurality of acknowledgment bits.
Clause 21. The communications node of clause 20, wherein the plurality of acknowledgement bits are dominant bits.
Clause 22. The communications node of clause 20, wherein the plurality of acknowledgement bits are recessive bits.
Clause 23. The communications node of any of clauses 13-22, wherein the response indicates whether the message or the frame of the message was received.
Clause 24. The communications node of any of clauses 13-23, wherein the response includes requested data.
Clause 25. A communications system, comprising: a commander node; and at least one responder node communicatively coupled to the commander node, wherein the responder node is configured to: receive, from the commander node, one or more frames of a message; receive, from the commander node, a request frame in a defined position relative to the one or more frames of the message; and send, to the commander node in response to the request frame, a response.
Clause 26. The system of clause 25, wherein the responder node is further configured to: send the response during a time period defined by the request frame.
Clause 27. The system of any of clauses 25 and 26, wherein the responder node is further configured to: send the response responsive to an SOF bit of the request frame.
Clause 28. The system of any of clauses 25-27, wherein the responder node is further configured to: send the response while receiving the request frame.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
receiving one or more data frames of a message;
receiving a request frame in a defined position relative to the one or more data frames of the message; and
sending, in response to the request frame, a response.

2. The method of claim 1, further comprising:
receiving the request frame as a frame of the message in a predetermined order within the message.

3. The method of claim 1, further comprising:
receiving the request frame within a predetermined time after receiving a last data frame of the message.

4. The method of claim 1, further comprising:
sending the response while receiving the request frame.

5. The method of claim 1, further comprising:
sending the response during a time period defined by the request frame.

6. The method of claim 1, further comprising:
sending the response responsive to an SOF bit of the request frame.

7. The method of claim 1, wherein sending the response comprises sending a response frame.

8. The method of claim 7, wherein the response frame includes a start of frame bit followed by a plurality of acknowledgment bits.

9. The method of claim 8, wherein the plurality of acknowledgement bits are dominant bits.

10. The method of claim 8, wherein the plurality of acknowledgement bits are recessive bits.

11. The method of claim 1, wherein the response indicates whether the message or the frame of the message was received.

12. The method of claim 1, wherein the response includes requested data.

13. A communications node configured to:
receive one or more frames of a message;
receive a request frame in a defined position relative to the one or more frames of the message; and
send, in response to the request frame, a response.

14. The communications node of claim 13, wherein the communications node is further configured to:
receive the request frame as a frame of the message in a predetermined order within the message.

15. The communications node of claim 13, wherein the communications node is further configured to:
receive the request frame within a predetermined time after receiving a last data frame of the message.

16. The communications node of claim 13, wherein the communications node is further configured to:
send the response while receiving the request frame.

17. The communications node of claim 13, wherein the communications node is further configured to:
send the response during a time period defined by the request frame.

18. The communications node of claim 13, wherein the communications node is further configured to:
send the response responsive to an SOF bit of the request frame.

19. The communications node of claim 13, wherein the communications node is further configured to:
send the response as a response frame.

20. The communications node of claim 19, wherein the response frame includes a start of frame bit followed by a plurality of acknowledgment bits.

21. The communications node of claim 20, wherein the plurality of acknowledgement bits are dominant bits.

22. The communications node of claim 20, wherein the plurality of acknowledgement bits are recessive bits.

23. The communications node of claim 13, wherein the response indicates whether the message or the frame of the message was received.

24. The communications node of claim 13, wherein the response includes requested data.

25. A communications system, comprising:
a commander node; and
at least one responder node communicatively coupled to the commander node, wherein the responder node is configured to:
receive, from the commander node, one or more frames of a message;
receive, from the commander node, a request frame in a defined position relative to the one or more frames of the message; and
send, to the commander node in response to the request frame, a response.

26. The system of claim 25, wherein the responder node is further configured to:
send the response during a time period defined by the request frame.

27. The system of claim 25, wherein the responder node is further configured to:
send the response responsive to an SOF bit of the request frame.

28. The system of claim 25, wherein the responder node is further configured to:
send the response while receiving the request frame.
